(19) United States
(12) Patent Application Publication
(10) Pub. No.: US 2005/0228620 A1
(43) Pub. Date: Oct. 13, 2005

(54) Method and apparatus for simulating a train and track

(75) Inventors: Damien Convert, Poisat (FR); Alain Houny, Saint Martin d'Heres (FR)

Correspondence Address: Joseph P. Krause;Vedder, Price, Kaufman & Kammholz, P.C., 222 North LaSalle Street, Chicago, IL, 60601, US

(73) Assignee: Corys Training & Engineering Support Systems, Paris (FR)

(21) Appl. No.: 10/820,555

(22) Filed: Apr. 8, 2004

(51) Int. Cl. G06F 17/50

(52) U.S. Cl. 703/1

(57) ABSTRACT

A train simulator simulates the operation of a train along actual track routes using actual locations and identities track events along an actual train route, Once a track event is specified and its location determined, the track event and surrounding terrain is simulated using software models of the track event and terrain, which are stored in databases of track event models and topographical models. The track, track events and surrounding terrain along the track can be more realistically simulated.

### FIELD OF THE INVENTION

This invention relates to a method and apparatus by which actual train routes can be simulated on a computer.

### BACKGROUND OF THE INVENTION

It's well known that computer-driven train simulators allow engineers to be trained without having to risk equipment or safety. In order to reproduce a realistic run on a simulator, it is necessary to re-create prior to the simulation session, a faithful visual representation of the track as well as the scenery observed by a locomotive engineer while driving the train on a given route. In the prior art, the track events composing the track route to be simulated (such as straight track, curves, grade, turnouts, crossings, signs, signals, etc.) are modeled using an appropriate software model for each track event, which is then manually “placed” at an appropriate position along the track. A problem with the prior art train simulators is that when performed manually, the process involved to place track event simulations with scenery representation in three dimensions is very time consuming when long distances are involved. Therefore, the track representation cannot be readily altered when a modification of a track event occurs on a given route. A need exists for a method and apparatus by which an actual train route can be simulated in three dimensions without having to manually assemble track event simulations.

### SUMMARY OF THE INVENTION

There is presented herein, a method and apparatus of simulating on a computer, an actual railroad track, including surrounding terrain. In the preferred embodiment, track events, such as straight and curved track segments, track switches, grade crossings, signals etc., are specified (identified) and located along an actual train route by geographic coordinates, e.g., latitude and longitude. A computer model of each track event, which enables a computer to present a three-dimensional simulation of each track event, is copied from a database of track event models and stored in a file referred to herein as a simulation file. The simulation file is a collection of models of track events, each of which is used by a computer to create a three-dimensional simulation of a track event that exists along an actual train route. By sequentially reading and executing track event models from the simulation file, a computer is able to sequentially simulate track events as they would occur along an actual track route.

Once a track event is specified and located, its surrounding environment is determined from one or more publicly-available data bases that catalogue topographical information about different latitudes and longitudes. A computer generates and displays on a screen, models of the track event as well its surrounding terrain and land coverage to present an on-screen simulation of an actual track event and an on-screen simulation of its environment. By knowing the location of track events along a route, the surrounding countryside, elevation, climate, and other events can be simulated by a computer's reading appropriate representations from one or more databases.

### BRIEF DESCRIPTION OF THE DRAWINGS

FIG. 1 is a representation of an actual track route that extends between a starting point and an ending point and which includes several track events.

FIG. 2 is a depiction of a computer simulated track and track event.

FIG. 3 is a blocked diagram of an apparatus for simulating a track route and a train on the track route.

FIG. 4A is a flow chart of a method of simulating an actual track route.

FIG. 4B is a continuation of the flow chart shown on FIG. 4A.

FIG. 4C is a continuation of the flow chart shown on FIG. 4A.

### DETAILED DESCRIPTION

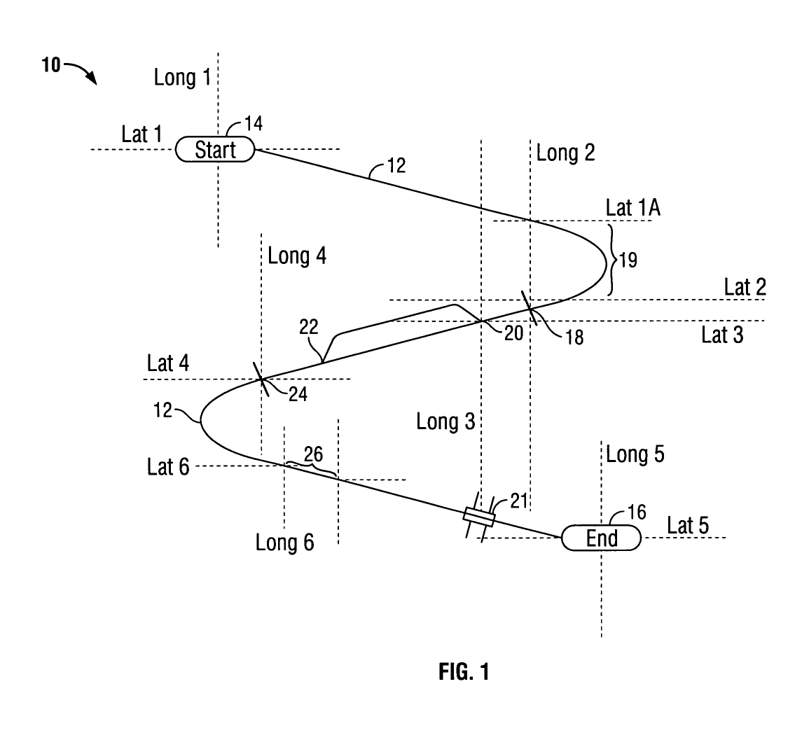

FIG. 1 is a representation of an actual train route 10 comprised of a section of actual railroad track 12 that extends between a starting point 14 and an ending point 16. The starting point 14 and the ending point 16 could be two cities (not shown in FIG. 1) between which extend hundreds or perhaps thousands of miles of track 12. The starting point 14 and the ending point 16 could also be two train yards, or two train stations or any other two points along a train route.

“Track events” occur at different locations along the track 12 between the starting point 14 and the ending point 16 and are things of importance to a train engineer. “Track events” include, but are not limited to, sections of straight or curving track, train signals or signs, (identified in FIG. 1 by reference numerals 18 and 24), track switches (identified by reference numerals 20 and 22) a curve or bend in the track, (identified by reference numeral 19) a pedestrian or vehicle crossing, (identified by reference numeral 21) and/or a grade (i.e., an incline or decline, identified by reference numeral 26), or other elements such as a bridge, an overhead power transmission, a tunnel, a platform (not shown in FIG. 1).

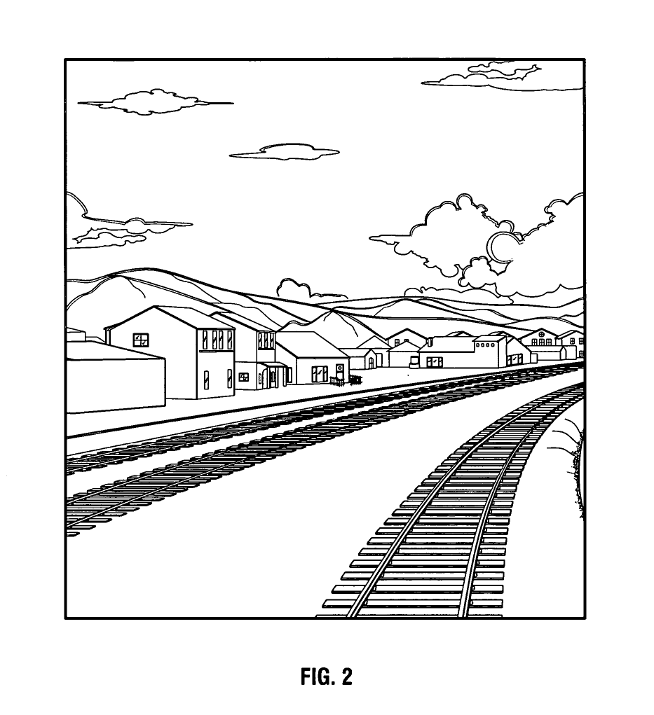

Each track event is part of an actual train track 12 that extends between the starting point 14 and the ending point 16. Each track event therefore has its own identity (i.e., what it is) as well as its own, actual location along the train route 10. By knowing what a particular track event is, as well as where it is located, a computer can generate on a display device, a three-dimensional simulation of the track event as it would appear to an engineer in a train locomotive running along the track 12. When a computer simulates a track event, a person viewing the computer's display device is presented with computer generated images that replicate what an engineer in a train locomotive would see as the locomotive travels along an actual track route, an example of which is shown in FIG. 2. By knowing where the track event is located along the route, its elevation and surrounding terrain can also be simulated for display thereby increasing the realism of a simulated train run.

For purposes of this disclosure, the term “simulate” should be construed to include the execution of computer program instructions by which a computer presents on a display device, a series of computer generated images that render a three-dimensional model of the experience of movement along a train track. “Simulation” includes the reproduction of any sensation, which a train engineer would experience when driving a train. Simulation can therefore include any sensory experience of a train engineer.

Programs that simulate three-dimensional movement are well known to those of ordinary skill in the art. Flight Simulator® is one example of a prior art program that simulates movement in three dimensions on a two-dimensional display. Techniques for simulating movement on a computer display are not germane to the invention disclosed and claimed herein and such techniques are omitted for brevity.

One way to specify a track event's location is by way of a relative location descriptor, such as a specified distance from one or more reference points or landmarks. While a relative location can be used to locate a track event, a preferable way to identify any location is by latitude and longitude coordinates, because latitude and longitude unambiguously locate a track event along the train route 10. As used herein, a track event's “location” should be considered to be specified by either latitude and longitude coordinates or by way of one or more relative descriptors.

In FIG. 1, the actual starting point 14 and the actual ending point 16 of the train route 10 are both uniquely identified by latitude and longitude coordinates. The coordinates of the starting point are identified as Lat₁ and Long₁. The coordinates of the ending point 16 are identified as Lat₅ and Long₅ respectively.

A railroad signal 18 is located at Lat₂ and Long₂. A track switch 20 is located at Lat₃, Long₃. A first track curve 19 is located between Lat_{1A}; Long₂ and Lat₂; Long₂. A second track curve 19 is located between Lat₄; Long₄ and Lat₆; Long₆. Sections of straight track can also be considered a track event, with a starting location and an ending location.

Each of the various types of track events that a train might encounter along a route is modeled in software. Software-based track event models are comprised of computer instructions and data that cause a computer to present on a display device coupled to the computer, a three-dimensional simulation of the particular track event, including simulating a train's movement relative to track events. By concatenating a series of track event simulations in a file, a computer can read the successive software models and present each of them in sequence on a display device so that the successive three-dimensional simulations produce a simulation of a train traveling along an actual track route.

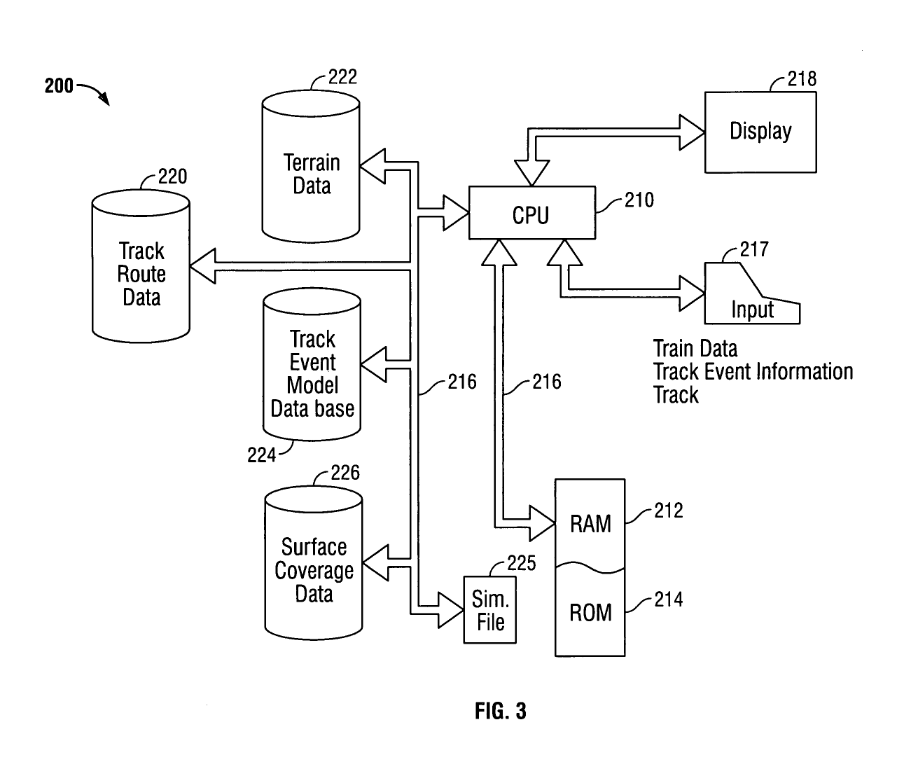

FIG. 3 is a block diagram of a computer system 200 for simulating an actual track route and for simulating a train on the simulated track. One or more, readily available personal computers will have processing capability sufficient to perform the aforementioned simulation.

The central processing unit or “CPU” 210 executes track and train simulation programs that are preferably stored in Random Access Memory (RAM) 212. At its most elementary level, the track simulation program instructions stored in memory cause the CPU 210 to perform many operations. In at least one embodiment, the computer system 200 receives the identity of a track event from either the input/output device 217 or from a file stored on another storage device or from another program running on the same CPU. Once a track event is identified, the track simulation program running on the CPU 210 reads a software model of the track event from the track event model database 224 and copies the software simulation for the track event into a simulation file. The simulation file can be located in either RAM 212 or a mass storage device 225, such as a hard disk drive.

After the simulation for a track event is stored as part of the “sim file,” a second track event can be specified and identified (from either an input/output terminal or read from a track event file or from another program). As track events are specified, the files that simulate them are read from the track event model database 224 and copied to the sim file storage device (RAM 212 or mass storage 225). In this way, a simulation of an actual track section can be built or assembled from models of various track events that exist between two locations.

In a preferred embodiment, the program instructions in RAM 212 cause the CPU 210 to receive or otherwise obtain the identity and the location of a track event. When the location of a track event is obtained, terrain data for the track event can be obtained from another database, sometimes stored on another storage device. Terrain data for a track event includes, but is not limited to, elevation above or below sea level. Terrain data can be used to identify whether a track event is located in a mountainous region or in some other type of terrain. By using the geographic location of a track event, the track event's elevation can be used to identify the kind of terrain proximate to the track event.

For purposes of this disclosure, the terms “surrounding” and “proximate’ should be considered synonymous, and broadly construed to mean an area that is near or proximate to the track event. Terrain that is proximate to a track event can include surface features that are within a few hundred feet but proximate terrain can also include mountain ranges or valleys within miles of a track event.

Once a terrain is known, a software model of the terrain can be executed by the computer system 200 to present a three-dimensional experience of the terrain from the perspective of the train engineer. When a terrain elevation is determined, the computer system 200 accesses a database of terrain models and can add the terrain simulation model to the track event model so that both the track event and its surrounding terrain are modeled and depicted in computer generated images on a display device.

In a preferred embodiment, simulations of terrain surrounding a track event are added to the sim file so that as track events are simulated, surrounding terrain is simulated, adding to the realism of the simulation. As set forth above, program instructions stored in memory cause the CPU 210 to present a simulation of both the track event and the terrain data on a display device 218.

As is well known, executable programs are usually read from a disk drive or other mass storage device and then copied into RAM 212 from which they are executed. Programs and data are copied from one or more disks and then executed by the CPU 210 using a bus 216, that couples the CPU 210 to the RAM 212, ROM 214 but which also couples the CPU to various mass storage devices 220, 222, 224, 225 and 226 in which various data bases and files are stored.

Although the mass storage devices 220, 222, 224, 225 and 226 are shown as separate devices, they can also be embodied as a single mass storage device that is divided into several logical devices, each of which stores separate data. Examples of suitable mass storage devices, could be CD-ROM, DVD, one or more hard disk drives accessible locally, or remotely via a network Those of ordinary skill in the art know that CD-ROM and DVD are not well-suited to provide fast access to the data stored on them. Accordingly, a sim file will usually be stored on a hard disk drive. (Executable programs can also be stored in read-only memory or ROM 214.)

An input/output terminal 217, (which can be a separate computer) is operatively coupled to the CPU 210 and enables a user to control operation of the simulator system 200. The input/output device 217 also enables operations such as train route selection but it also enables the display of the simulation of the track and track events on a screen such as a CRT, LCD screen, projection TV or other display device 218. The particular topology of input/output device—CPU and display device is not critical to the invention disclosed and claimed herein.

In one embodiment, four different physical or logical storage devices 220, 222, 224, and 226 each store a separate database. As set forth above, such devices can be embodied as hard disk drives, CD-ROM drives, tape or even floppy disks or a DVD. Whether such devices are physical devices or logical devices is not critical. A hard disk drive, identified by reference numeral 225, stores the sim file that is constructed from simulations of various track events.

Storage device 220 is labeled “track route data,” which is a database of actual track routes between various points of an area. The track route database will include parameters such as a track route's starting point and ending point, preferably by the latitude and longitude coordinates of both the starting and ending points.

A second storage device 222 is labeled “terrain data”, which is a database of information on the elevation of terrain of points. This database is used by the simulation software to obtain the elevations of the points, identified by latitude and longitude or a relative description, throughout an area through which a train route passes. By knowing the elevation of a track event, the software that performs the function of a train simulator can more faithfully simulate a train climbing or descending a hill or simulate the effects of high or low altitude on a train's locomotive. One example of a terrain database are the databases provided by the United States Geological Service, Agencies of other governments might provide the same or comparable information as well. Private companies might also provide terrain data. Any database that provides elevation data by geographic coordinates could also be used in embodiments of the invention that use track event elevations. The elevations could be stored in the terrain database under different formats, for example USGS Digital elevation Models (DEM) or Digital Line Graph (DLG). The terrain data stored in the second storage device 222 preferably includes terrain data for each track event along every possible track route stored in the track route data base on the first storage device 220. In at least one alternate embodiment, the terrain data can include climatic information as well. In such an embodiment, climatic conditions for the train's locomotives can be obtained and passed to the software that simulates the train and its locomotives.

A third storage device 224 is labeled as a track event model database. The track event model database stores computer files by which a computer, such as the CPU 210, can simulate track events, such as the track events shown in FIG. 2. As set forth above, simulation requires generating three-dimensional representations of various track events and presenting them on a two-dimensional display device 218, similar to the way that the track event would appear from a train locomotive as the locomotive travels along track. The track event model database stores software representations of straight rail road track, track switches, signals, various track curves to the left and right, track embankments, and ascending or descending track grade, a grade crossing, an overpass or other events that can occur along a train track. The software representations of track events enable a computer to present computer-generated images on screen that create the appearance of movement toward or away from each type of track event. By copying models of track events from the track event model database storage device 224, into a sim file on a hard disk drive 225, the CPU 210 can later read and execute successive track event simulations from the sim file and display on a display device 218, a simulation of each track event along an actual train route.

The third storage device 224 can also store software models of various kinds of terrain. When a terrain for a track event is identified, one or more programs that simulate the terrain surrounding can read their model in the third storage device 224 and add it to the simulation file for execution at a later time.

In another embodiment, a fourth storage device 226 stores surface coverage information. Information in the surface coverage information database stored in storage device 226 includes computer-executable descriptors, (i.e., simulations) of surface coverage at different latitude and longitude coordinates. For example, the surface coverage database would include files by which the CPU could generate on a display device, representations of urban areas, rural areas, rivers, forests, water surface, vegetation and housing density and other surface characteristics.

As set forth above, the system 200 of FIG. 2 uses actual locations of a starting point 14 and ending point 16 of a train route 10 to simulate both the track 12 and the track's surroundings. Virtually any section of track can be simulated so long as actual events along the track 12 are identified and a model of the track events along the route are available. In other words, the CPU 210 can present on a display device, any sequence of track event simulations that are stored in the aforementioned sim file. By merging a simulation of track events with simulations of the track event elevations and/or simulations of surrounding countryside, a more lifelike simulation of actual track is realized. I

While the computer system 200 of FIG. 2 can present simulations of track events and scenery that exist along an actual section of track, the computer system 200 can also simulate a train traveling along the section of track that is being simulated. In other words, the system 200 can also be used to generate a display and simulation of track sections that are themselves simulated. In such an application, a starting and ending point can be selected and terrain models selected as desired.

Prior art, computer-driven train simulators are known, an example of which is disclosed in U.S. Pat. No. 4,041,283 to Mosier for a “Railway Train Control Simulator and Method” and U.S. Pat. No. 4,853,883 to Nickles et al. for an “Apparatus and Method for Use in Simulating Operation and Control of a Railway Train.” The CPU 210 shown in FIG. 2 should be considered as representing one or more processors/computers by which the track can be simulated but by which a train can also be simulated. Inasmuch as the terrain over which a train travels will affect how a train operates, the simulation of a train will be affected by the track over which the simulated train travels. Accordingly, it is preferred to have the train simulation cooperate with the track simulation so that track conditions can be included in the train's simulation.

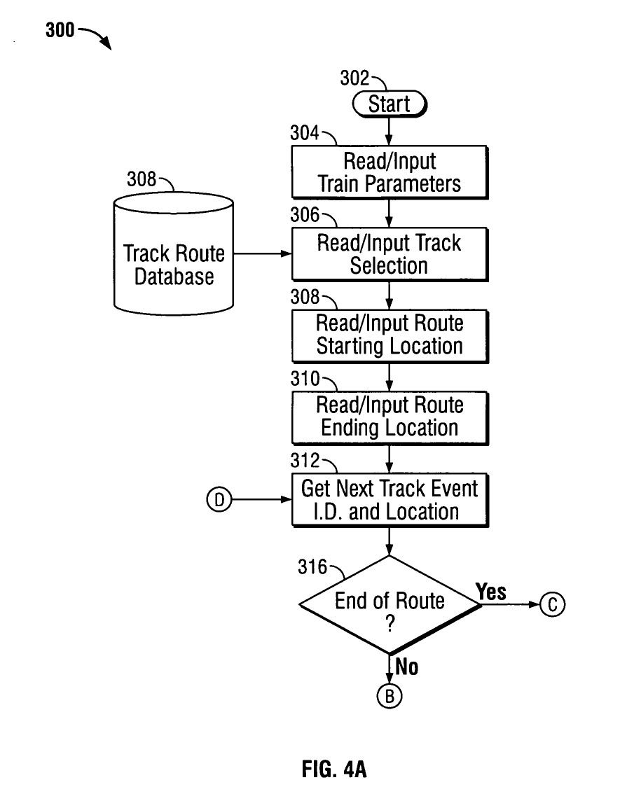

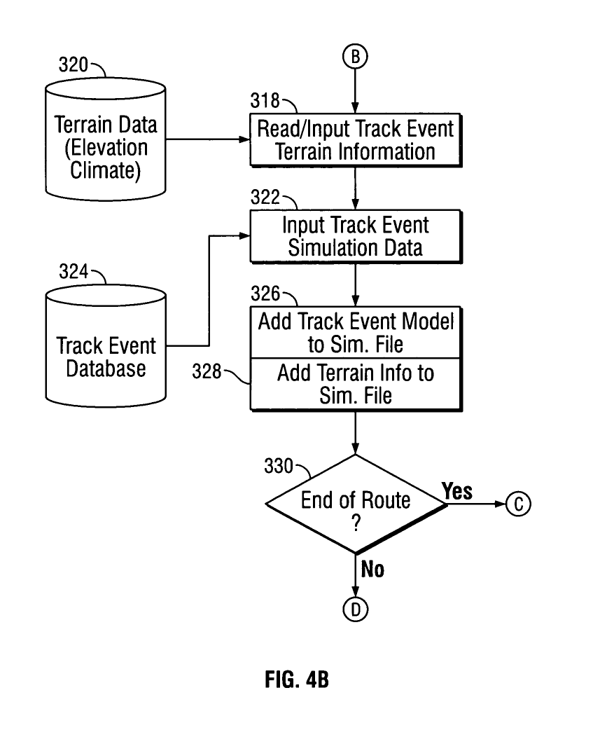

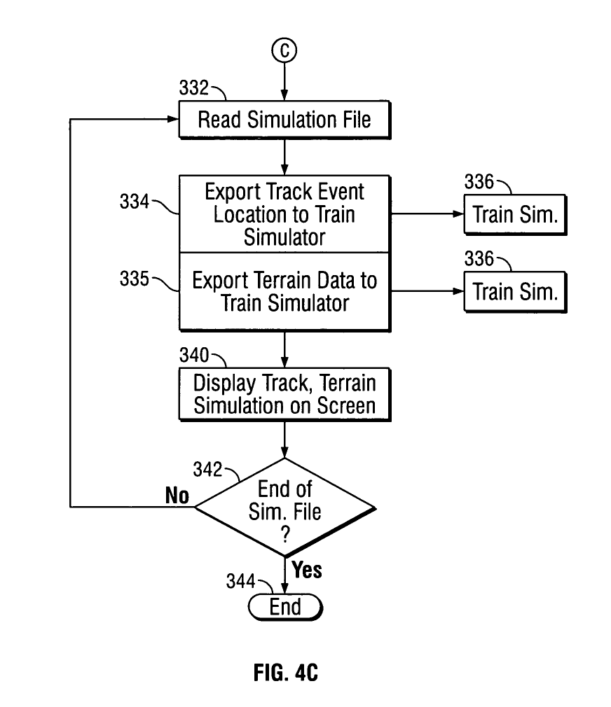

FIG. 4A shows steps of a method for simulating a train along an actual section of track. Program execution begins at step 302, which typically includes steps such as blanking the display device 218, showing a start-up banner on the display device 218 and/or soliciting input from the operator at the input/output terminal 217.

At step 304, in one embodiment, parameters of a train to be simulated along a section of track are solicited from a user and received from the user via the input/output terminal 217. By way of example, at step 304 the user would specify the number of locomotives, the number and types of cars and the load in the cars can be specified. Such parameters will affect operating characteristics of a train that is simulated by the computer system 200.

At step 306, the user selects a track route from a track route database 308 using input commands via the input/output terminal 217. As set forth above, the track route database is stored on a storage device 220 accessible to the CPU 210. In step 306, the user can select one or more sections of connected track listed in the track database 308 to build a track route over which a simulated train will travel. By way of example, user might select a train route between Chicago and Los Angeles, which passes through southern states. Alternatively, the user could select a train route that extends between Chicago and Los Angeles that passes through northern states.

At step 308, the CPU 210 reads from the input terminal 217 or from the track route database 308 the actual location of the starting point of the route selected in step 306. At step 310, the actual location of the ending point of the route is read in a similar fashion. In a preferred embodiment, actual locations of track events and starting and ending points are all specified by latitude and longitude coordinates.

Between the starting location and the ending location are one or more “track events,” which are herein considered track conditions or things that occur along or which are part of a railroad track. Examples of track events include but are not limited to: sections of straight or curved track, a track switch, a train signal, a track curve, increasing or decreasing track grades or hills, grade crossings over which vehicles and pedestrians might travel, bridges or other trains either in front of or behind the simulated train. Track events can be simulated by the computer system 200 such that they appear on the display device 218 as someone would experience them from a train locomotive.

In step 312, the CPU 210 reads or is provided with a “track event” from the input/output device 217 or from a track event file. A track event file is a computer file that specifies a series of separate track events, including actual locations of each. Track events can also be input to the computer 210 via a file transfer from a track event database (not shown in FIG. 2) or from an external data source, such as a file external to the computer system 200 but accessible to the computer system 200 via a data network (not shown). For purposes of this disclosure, reading a track event from a file and receiving an input string or command from a terminal, are different embodiments of the same thing, i.e., obtaining for, or by, the computer, an identity and/or location of a track event.

As set forth above, a track event is “specified” or “identified” when its actual location is provided to or obtained by the computer system 200, preferably by latitude and longitude coordinates. Inasmuch as the latitude and longitude unambiguously specify the location of a track event, they also enable the acquisition of surrounding terrain data from other databases described above. In an alternative embodiment, actual locations of track events can be specified by a track event's relation to land marks, e.g., a certain distance or direction from an identifiable point or location.

After a track event and its actual location are obtained in step 312, a test is performed in step 316 to determine whether the actual location of the track event obtained in step 312 is at or near the end of the route obtained in step 310. If the track event is near the end of the route, program control proceeds to step 332, which is depicted in FIG. 4C, which is described more fully below. If the end of the route has not been reached, program control proceeds to step 318, which is depicted in FIG. 4B.

Step 318 is performed after track event specification where the track event is not the end of the track route. In other words, if the end of the track route has not been reached, information about the surrounding terrain of the track event is read from a terrain database, identified in FIG. 4B by reference numeral 320, one example of which would include a U.S. Geological Service terrain database. Other data base of other geographic areas could be used as well. Those of skill in the art will recognize that other terrain databases of other publishers could be used as well. As shown in FIG. 2, surrounding terrain information can be stored on one or more storage devices such as the device identified by reference numeral 222 in FIG. 2.

Information about the terrain surrounding a track event is obtained using the actual location of the track event. In one embodiment, the latitude and longitude of a track event can be used as an index into a database, such as the U.S. Geological Service terrain database to obtain information such as the elevation of the track event, but also information about the surface area surrounding the track event. By way of example, if the latitude and longitude of a track event is known, its elevation, surrounding climate, and surface coverage can be readily determined. Surrounding terrain information includes, but is not limited to information such as ambient temperatures for a given time of year and the surrounding area (e.g., urban or rural; plain or mountainous terrain).

At step 322, the computer reads track event simulation data from a database of track event simulation files, which are identified in FIG. 4B by reference numeral 324. Such files enable a computer system 200 to simulate and display on a display device 218, the occurrence of the track event obtained in step 312. Track event simulation data would include information on how the computer CPU 210 will present a representation of the experience of a track event on the display device 218. For instance, the track event simulation data enables the CPU 210 to present on the display device 218 a simulation of a track switch or a track signal at the speed at which the simulated train is traveling.

A track event simulation database 324 is stored in a track event database storage device 224. Such a storage device is identified by reference numeral 224 in FIG. 2. Software models of track events such as straight track, switches, signals, etc. are stored on the track event storage device 224 from which they can be read by the CPU 210 and copied or appended to the aforementioned sim file.

In steps 326 and 328, the track event simulation data obtained in step 322 and the terrain information obtained in step 318 is used as part of the simulation file described above. The simulation file is comprised of software models that cause the CPU 210 to display a representation of a three-dimensional experience of each track event. Once the simulation file is assembled, the CPU can present the sim file's contents as a sequential occurrence of events on the display device 218 thereby presenting to the user of the simulator 200 a simulation of a complete actual train route between starting and ending points.

As these simulation files are executed, the end of the route is detected at step 330 whereupon the program execution proceeds to step 332 shown on FIG. 4C. At step 332 the simulation file assembled in steps 326 and 328 is read from memory (preferably RAM) followed by the exportation of the track event data in step 334 to the train simulator software 336. The train simulator software 336 simulates the behavior of the simulated train components in response to the various track events. Exporting the track events and their location to the train simulator 336 enables a more faithful simulation of the operation of the train specified in step 304 on the display device 218. If for example, a track event includes a hill over which the simulated train must travel, increased locomotive load caused by a grade can be simulated by the computer system 200 slowing the presentation of track on the display device 218 to make it appear that the train is slowing as it ascends a grade. At step 335, terrain data obtained in step 318 can be exported to the train simulator so as to modify the display of the surrounding terrain simulation on the display device 218.

At step 340, the complete simulation is presented on the display device 218 including the simulated travel of the train along the track, the occurrence of track events and surrounding countryside. Program execution loops back to step 332 until the simulation file ends, as detected in step 342. When the simulation file ends, program execution ends at step 344.

Returning to step 330, at the end of the train route has not been reached, program control returns back to step 312 where the next track event is obtained from the input/output terminal 217 or read from a file or other source. The end of the track route is tested in step 316, followed by the retrieval of terrain information for the track event and simulation data for the track event as set forth above and described with regard to step 318 and 322.

In should be apparent from the foregoing that a more realistic and life-like train simulation can be realized by using actual locations of actual track events that enable the presentation of the surrounding terrain and a more life like simulation of the train's behavior as it crosses an actual track route. By specifying the locations of track events using latitude and longitude coordinates, databases that describe the terrain and surrounding surface coverage area can be used to faithfully recreate track simulations that can be created in real time.

While the preferred embodiment relies on track event models stored in a sim file from where they are successively read and executed, an alternate embodiment of the invention does not use a sim file but executes track event models as they are needed in real time. In such an alternate embodiment, the layout of an actual train route is specified whereby the sequence of track events is specified. A first track event is specified to or by a computer. When a track event is specified, its software model is retrieved from storage and executed by the computer.

As one track event is being simulated, the computer reads the track route descriptor and obtains the identity of a second track route. After the second track route is determined, its software model is retrieved from storage and prepared for execution after the conclusion of the simulation of the first track event.

In an alternate embodiment that does not use a sim file, track events can be specified a number of ways. Track events could be input to the simulator software by way of a terminal. Track events could also be specified by entries in a list or table that is read by the computer to determine the sequence in which models of track events should be presented.

From the foregoing it should be apparent that an actual train run can be simulated using simulations of actual train routes. Simulating scenery and ground coverage as it would exist around actual track events enables a more realistic simulation.

1. A method of simulating on a computer an actual track route, the method comprised of the steps of:
specifying to the computer, a track event along an actual track route;
reading a track event database by the computer to obtain a software model of the track event by which the track event can be simulated on the computer; and the computer presenting a simulation of the track event on a display device using the software model of the track event.

2. The method of claim 1 wherein the step of specifying a track event along an actual train route includes the step of specifying the location of the track event.

3. The method of claim 2 further including the step of:
specifying to the computer, a terrain database from which to read terrain information for the terrain proximate to the track event;
reading terrain information for the track event from the terrain database;
reading a terrain model database to obtain a software model of the terrain proximate to the track event by which the terrain can be simulated on the computer; and
said computer presenting a simulation of the terrain proximate to the track event.

4. The method of claim 1 further including the step of: storing the software model of the track event in a simulation file.

5. The method of claim 1 further including the steps of:
reading a surface coverage database from which to obtain information on the surface coverage of terrain surrounding the track event;
reading a surface coverage simulation database to obtain a software model of the surface coverage surrounding the track event and by which the surface coverage surrounding the track event can be simulated on the computer; and
the computer generating a simulation of the surface coverage surrounding the track event.

6. The method of claim 3 wherein the information input to said computer from the terrain database includes information from a U.S. Geological Survey database.

7. The method of claim 2 wherein said actual location includes the latitude and longitude coordinates of track events.

8. The method of claim 3 wherein the proximate terrain information includes the elevation of the location of the first track event.

9. The method of claim 3 wherein the proximate terrain information includes climatic information for the location of said first track event.

10. The method of claim 1 wherein said first track event includes at least one of:
a section of straight track;
a track switch;
a train signal or sign;
a track crossing;
a track curve; a track grade;
a bridge
a platform
a tunnel
an over-head power transmission

11. A method of simulating on a computer an actual track route, the method comprised of the steps of:
specifying a track event along an actual track route to the computer;
specifying the actual location of the track event;
reading a track event model database by the computer to obtain there from, a software model of the track event by which the track event can be simulated on the computer; and
the computer generating a simulation of the track event on a display device, using the software model of the track event;
the simulation of the track event including a simulation of the actual terrain proximate to the track event.

12. The method of claim 11 further including the step of: storing the software model of the track event in a simulation file.

13. The method of claim 11 further including the steps of:
the computer obtaining surface coverage information for terrain proximate to the track event;
the computer obtaining a software model for terrain proximate to the track event; and
the computer generating a simulation of the surface coverage proximate the track event.

14. The method of claim 11 wherein said actual location includes the latitude and longitude of the track event.

15. The method of claim 11 wherein the proximate terrain information includes the elevation of the location of the first track event.

16. The method of claim 11 wherein said proximate terrain information includes climatic information for the location of said first track event.

17. The method of claim 1 wherein the track event includes at least one of:
a section of straight track;
a track switch;
a train signal;
a track crossing;
a track curve; a track grade
a bridge
a platform
a tunnel
an over-head power transmission

18. A method of simulating in a computer, the operation of a train along a track route comprised of the steps of:
identifying the starting and ending points of an actual track route to be simulated;
specifying to the computer, the location and the identity of a track event between the starting and ending points of the track route;
reading a track event database by the computer to obtain a software model of the track event by which the track event can be simulated on the computer;
said computer obtaining from a terrain database, information about the terrain surrounding the track event; and
said computer presenting on a display device that is coupled to said computer, a simulation of the track event, using the software model of the track event and the terrain information.

19. The method of claim 18 further including the steps of:
inputting to the computer, parameters of a train to traverse said track route; and
said computer presenting on a display device, a simulation of the train encountering the track event.

20. The method of claim 18 further comprised of the step of:
simulating the train's response to the terrain surrounding said track event.

21. The method of claim 19 further including the step of:
the computer reading a simulation of the surface coverage of terrain proximate to the first track event.

22. The method of claim 18 wherein the information input to said computer from said first database includes information from a U.S. Geological Survey database.

23. The method of claim 18 wherein said actual location includes the latitude and longitude coordinates of track events.

24. The method of claim 18 wherein said first track event includes at least one of:
a section of straight track;
a track switch;
a train signal;
a track curve; a track grade
a bridge
a platform
a tunnel
an over-head power transmission.

25. A method of simulating on a computer, the operation of a train along an actual track route comprised of the steps of:
inputting to the computer, the latitude and longitude coordinates and the identity of a track event along the actual track route;
said computer obtaining from a storage device a software model of the track event;
storing the software model of the track event in a simulation file;
said computer executing the software model of the track event from the simulation file; and
the computer displaying a three-dimensional simulation of the track event on a display device.

26. A method of simulating on a computer, the operation of a train along an actual track route comprised of the steps of:
inputting to said computer, the location and identity of a track event along said track route;
obtaining a software simulation of the track event from a track event simulation database;
obtaining terrain information for the location of the track event from a terrain database;
obtaining local land coverage information for the location of the track event from surface coverage database;
obtaining a software simulation of the surface coverage surrounding the track event;
storing the software simulation of the track event in a simulation file;
storing the software simulation of the surface coverage in the simulation file;
displaying on a display device, a simulation of the track event using the software simulation of the track event stored in the simulation file;
displaying on a display device, a simulation of the terrain around the track event using the software simulation of the surface coverage in the simulation file.

27. A method of simulating on a computer, the operation of a train along an actual track route comprised of the steps of:
inputting to said computer, the location and description of a plurality of track events along said track route;
obtaining from a track event model database, a software model for each track event;
storing a software model for each track event along the track route in a simulation file;
displaying on a display device, the simulations of the track events along the track route using the software models of track events stored in the simulation file.

28. A method of simulating on a computer, the operation of a train along an actual track route comprised of the steps of:
inputting to said computer, the location and description of a plurality of track events along said track route;
obtaining from a track event model database, a software model for each track event;
obtaining from a terrain database, terrain information for each track event along the track route;
storing a software model for each track event along the track route in a simulation file;
storing the terrain information for each track event in the simulation file;
displaying on a display device, the simulations of the track events along the track route using the software models of track events stored in the simulation file and using the terrain information stored in the simulation file.

29. A system for displaying the operation of a train along an actual track route comprised of:
a processor;
a display device operatively coupled to the processor;
an input/output device operatively coupled to the processor, through which at least track events along an actual train track can be specified to the processor;
a storage device, operatively coupled to said processor, said storage device storing computer program instructions and data, which when executed, cause the processor to present on the display device, a simulation of the track event along an actual train route using a software model of the track event that is stored in a memory device that is operatively coupled to the processor.

30. The system of claim 30 wherein the storage device stores instructions which when executed cause the processor to present on the display device, a simulation of track events using terrain data for terrain that is proximate to the track event.

31. A system for displaying the operation of a train along an actual track route comprised of:
a processor;
a display device operatively coupled to the processor;
an input/output device operatively coupled to the processor, through which track events along an actual train track can be specified to the processor by their type and actual location;
a storage device, operatively coupled to said processor, said storage device storing computer program instructions and data, which when executed, cause the processor to:
store software simulations of track events in a simulation file;
read software simulations stored in the simulation file and sequentially present on the display device, a simulation of a track event along an actual train route using a software model of the track event that is stored in the simulation file.
